(19) United States
(12) Patent Application Publication
(10) Pub. No.: US 2011/0042931 A1
(43) Pub. Date: Feb. 24, 2011

(54) Pole Straps Spreader Device

(76) Inventor: Daniel Hunter Hoggan, Providence, UT (US)

Correspondence Address: Daniel H. Hoggan, 955 Foothill Drive, Providence, UT, 84332, US

(21) Appl. No.: 12/916,510

(22) Filed: Oct. 30, 2010

Related U.S. Application Data
(63) Continuation of application No. 12/139,694, filed on Jun. 16, 2008, now abandoned.
(60) Provisional application No. 60/946,720, filed on Jun. 28, 2007.

(51) Int. Cl. A63C 11/22; B23P 17/04

(52) U.S. Cl. 280/821; 29/428

(57) ABSTRACT

A spreader device that attaches to the straps of a ski pole or similar pole holding the straps apart so that it is easy for a user to grasp or release the grip of the pole. It is constructed of rubber, plastic, or metal with resilient, spring-like characteristics. The device has two removable parts that may be used together or alone, and will fit the straps of most poles. It is very simple in design and inexpensive to manufacture, so it can be made available at a very affordable price.

### CROSS REFERENCE TO RELATED APPLICATIONS

This is a continuation of application Ser. No. 12/139,694, filed Jun. 16, 2008, now abandoned. This continuation application claims the benefit of provisional application, No. 60946720, filed: Jun. 28, 2007 by the present inventor.

### STATEMENT OF FEDERALLY SPONSORED DEVELOPMENT

Not Applicable

### REFERENCE TO A SEQUENCE LISTING

Not Applicable

### BACKGROUND

1. Field of Invention

This invention relates to sports and exercise equipment, specifically to spreaders applied to straps on ski poles used for snow skiing and to straps on similar poles.

2. Prior Art

In the current state of the art the two straps attached to the top of a ski pole when fastened together with a buckle serve to attach the pole to the hand and wrist of a skier. The purpose of the straps is to provide a secure connection between the hand of the skier and the pole and also to prevent separation of the pole from the skier in a fall or other situation that may result in the inadvertent release of the pole. A pole separated from a skier while skiing may result in loss of the pole in deep snow, and in some cases a loose pole may become a safety hazard to the skier or to others.

When a ski pole is not in use, the two straps tend to hang side by side from the top of the pole with little or no space between them. To grasp the pole and get ready to ski, the skier must first open up a loop between the buckled straps through which he or she can insert a hand. This generally takes both hands of the skier—one to hold the loop open enough so that the other hand can be inserted through the loop to grasp the grip of the pole. This tends to be somewhat awkward and time consuming especially with heavy ski gloves or mittens. Releasing the hand from within the loop also requires two hands and is somewhat awkward.

A spreader for ski pole straps is disclosed in U.S. Pat. No. 6,386,588 to Young, et al (2002). The disclosed spreader is part of an elaborate ski pole grip and strap system that has a spreader attached to the top of a pole's grip in a slot with a pin. This spreader requires a ski pole with a specially designed and manufactured grip and strap attachment. It would not fit any other ski pole, so has very limited application. Two other patents, U.S. Pat. No. 3,923,317 to Penny (1975) and U.S. Pat. No. 4,082,303 to Finnegan (1978) disclose straps with openings for grasping the grip of a ski pole, but both of these require specially designed and manufactured straps that would not fit on other poles. One of the primary advantages of the spreader device applied for in this patent application over the prior art is that it has essentially universal application and will fit on the straps of almost all ski poles. U.S. Pat. No. 6,385,819 B1 to Ingold (2002) is for a device that attaches to the two straps of a ski pole at a position over the top of the buckle that holds the two straps together. A disadvantage of this device is that it has a permanent connection and interferes with the function of the buckle in adjusting the size of the loop between the straps. Some skiers like to adjust the fit of the loop each time they use a ski pole, and this device would be a nuisance for them. Another advantage of the device applied for in this patent application is that it does not restrict the function of the buckle in adjusting the size of the loop in the straps.

The device disclosed herein provides an open loop large enough to easily insert or remove the gloved hand of a user without help of the other hand, and does not adversely affect the function of the straps. Once the hand is in place within the loop and the user grasps the pole, the spreader device flexes slightly and conforms to the shape of the gloved hand. Although this device is described for use with ski poles, it could be used with any type of pole that has straps for securing the pole to a hand. Examples of other such poles are those used for walking and snow shoeing.

### BRIEF SUMMARY OF THE INVENTION

This device consists of two parts, an upper spreader and a lower spreader that are attached to the straps of a ski pole. There are two basic embodiments of the upper spreader—one embodiment hereinafter referred to as a slip-on upper spreader is composed of a single piece of rubber, plastic, or metal that is flat and generally rectangular in shape, approximately 1¼″ wide×2½″ long× 1/16″ thick with four slots. This slip-on upper spreader is installed by inserting the ski pole straps into and through the four slots and then slipping the spreader up the straps until it is in its final position at the upper ends of the straps near the top of the ski pole. The other one of the aforementioned two embodiments hereinafter referred to as a snap-on upper spreader is comprised of two flat V-shaped parts that are fastened together with rivets and/or snaps. The straps of the ski pole are sandwiched between the two parts of the snap-on spreader and held at a predetermined angle when the snaps on the spreader are fastened. The lower spreader has two slots and a notch for holding the straps and causing them to separate and open a loop between them when the straps are buckled together. The upper and lower spreaders may be used together on the same pair of straps or they may be used alone, each one independently providing a significant loop opening. The open loop makes it easier for a user to insert his or her hand between the straps and grasp the grip of the pole. It also makes it easier to remove the hand from within the straps.

### BRIEF DESCRIPTION OF THE DRAWINGS

FIG. 1 is a side view of a ski pole showing the straps in open position with the slip-on upper spreader and the lower spreader in place.

FIG. 2 is a front view of the slip-on upper spreader showing the location of two smaller slots on one end and two larger slots on the other end.

FIG. 3 is a side view of one design of the slip-on upper spreader showing it to be essentially a flat plate with slots.

FIG. 4 is a side view of an alternative design of the slip-on upper spreader in which said spreader is essentially a curved plate with slots.

FIG. 5 is a top view of the lower spreader showing the location of two slots at one end and a notch at the other end.

FIG. 6 is a side view of a top portion of a ski pole showing the straps in open position with the snap-on upper spreader in place.

FIG. 7 is cross-sectional view of a portion of the snap-on spreader in place.

The reference numbers are assigned as follows:
6 Slip-on upper spreader
7 Lower spreader
8 Inside small slot in 6
9 Outside small slot in 6
10 Ski pole strap without a buckle
11 Inside large slot in 6
12 Outside large slot in 6
13 Ski pole strap with a buckle
14 Buckle
15 Outside small slot in 7
16 Inside small slot in 7
17 Notch in 7
18 Top of ski pole
19 Outside edge of 7
20 Ski pole grip
21 Opening between straps 10 and 13
22 Indentation in 7 that forms a cradle for grip
23 Left leg of upper flat plate
24 Left leg of lower flat plate
25 Right leg of upper flat plate
26 Right leg of lower flat plate
27 Snap
28 Snap or rivet
29 Snap
30 Snap or rivet

### DETAILED DESCRIPTION OF THE INVENTION

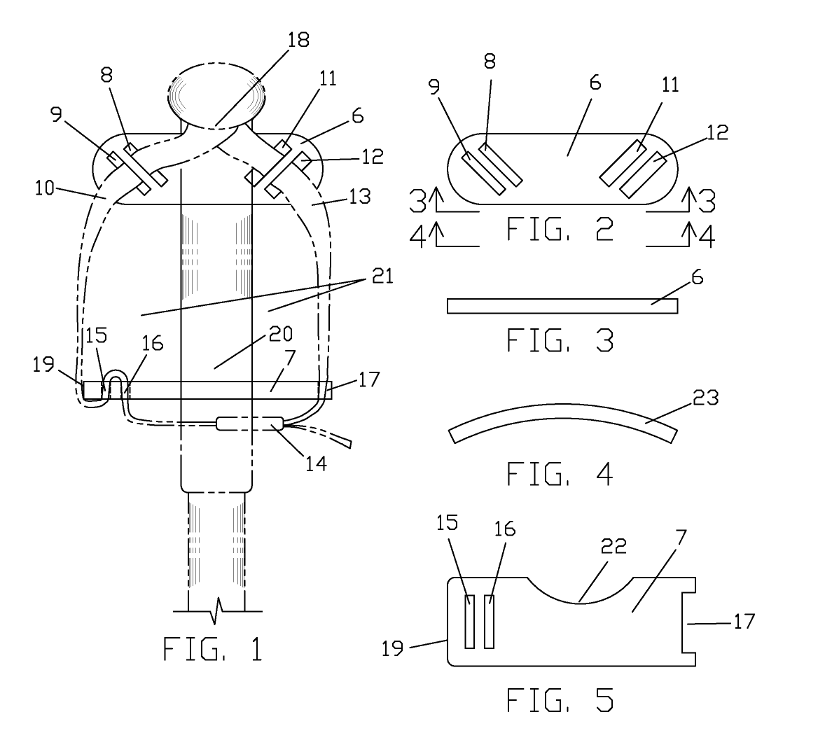

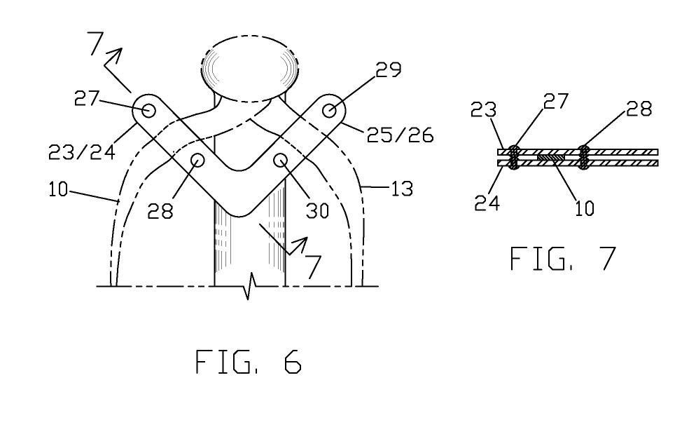

This spreader device consists of two parts, an upper spreader and a lower spreader that are attached to the straps of a ski pole. There are two embodiments of the upper spreader—one embodiment is hereinafter referred to as the slip-on upper spreader and the other embodiment is hereinafter referred to as the snap-on upper spreader. There is only a single embodiment of the lower spreader. The slip-on upper spreader and the lower spreader each consists of a flat piece of rubber, metal, or plastic in a rectangular shape approximately 1¼″ wide×2½″ long× 1/16″ thick with openings to fit the straps and buckle of a ski pole in a particular manner as will subsequently be explained. The slip-on upper spreader and the lower spreader are shown attached to the straps of a ski pole in FIG. 1. The two parts by themselves are shown in FIGS. 2-5. The snap-on upper spreader is comprised of two similar flat V-shaped plates that are fastened together with rivets and/or snaps. The straps of a ski pole are held at a predetermined angle between the flat plates of this spreader when they are fastened together. The snap-on upper spreader is shown attached to the straps of a ski pole in FIG. 6. A cross sectional view of part of said snap=on spreader is shown in FIG. 7.

The slip-on upper spreader 6 is a flat plate with two small parallel slots 8 and 9, each approximately ⅛ in.×1 in. in size, located on one end and positioned at an angle of about 45 degrees with the longitudinal axis. See FIG. 2. The slots are rectangular in shape and each sized to hold strap 10. Two larger parallel slots 11 and 12 are located similarly on the other end of the plate have openings slightly larger than the first two just described. These two are each large enough to pass the buckle 14 on the end of ski strap 13 and are also positioned at an angle of about 45 degrees with the longitudinal axis, but oriented in an opposite angle from the other two slots.

The snap-on upper spreader in FIG. 6 and FIG. 7 is comprised of two flat plates which are each die cut or molded in a similar V-shape (or U-shape, not shown) with corresponding legs 23 and 24 of the “V” fastened together on the left side and corresponding legs 25 and 26 fastened together on the right side. The two snaps, 27 and 28, serve to fasten the left ski pole strap 10 in between legs 23 and 24, and the two snaps 29 and 30 serve to fasten the right ski pole strap 13 in between legs 25 and 26. The snaps may be external off-the-shelf fasteners which are attached to the opposing surfaces of the plates in the spreader to be fastened, or in the case of injection molded plates they may be molded in the plates themselves. Rivets may be employed in place of the two interior snaps 28 and 30 for a more permanent fastening. The ski pole straps thus held at predetermined angles and locations within the legs of the snap-on upper spreader create an opening or loop in the straps.

The second part of said spreader device, designated as the lower spreader 7, is a flat plate with two small parallel slots 15 and 16 for holding strap 10 on one end, each at an angle of 90 degrees with the longitudinal axis. See FIG. 5. On the other end, the plate has a single notch 17 in the outside edge large enough to pass strap 13 with buckle 14.

Installation of the slip-on upper spreader 6 is described first with reference to FIG. 1. The strap without a buckle 10 is passed down through the inside slot 8 and threaded up through outside slot 9 of the slip-on upper spreader. The strap 10 is then allowed to hang down vertically to be in position to be inserted into the lower spreader 7. Next, the other strap 13 with a buckle 14 is passed down through inside slot 11 and threaded up through outside slot 12 of the slip-on upper spreader 6. This strap with a buckle is then allowed to hang down vertically to be in position to be passed through the notch 17 in lower spreader 7 for subsequent attachment to the end of strap 10. While the free ends of the two straps 10 and 13 are held securely, said slip-on upper spreader 6 is pushed up to the upper end of the straps next to the top of the ski pole grip 18.

The installation of the snap-on upper spreader is described with reference to FIG. 6 and FIG. 7. With the inner snaps 28 and 30 closed, the snaps 27 and 29 are opened so that the ski pole straps 10 and 13 can be placed between the upper and lower legs of the spreader plates. The upper part of the left ski pole strap 10 is placed between legs 23 and 24, and the upper part of the right ski pole strap 13 is placed between legs 25 and 26. After the ski pole straps are in place, snaps 27 and 29 are snapped together thereby holding the straps in a position to form an open loop.

The lower spreader 7 is installed after the upper spreader is in place. The strap without a buckle 10 is passed down around the outside edge 19 of the lower spreader 7 and threaded up through the outside slot 15 and down through inside slot 16. The strap 13 with buckle 14 is then passed down through the notch 17, and fastened to the other strap 10 underneath the lower spreader 7. With the lower spreader 7 in this position near the bottom of the grip 20, and with the upper spreader (either the slip-on embodiment or the snap-on embodiment) in position near the top of the grip, the upper and lower spreaders function together to hold straps 10 and 13 apart and form an opening 21. The aforementioned upper and lower spreaders together provide an ample opening 21 for insertion of a gloved hand with little or no assistance from the skier's other hand. The design of the lower spreader 7 with an oversized notch 17 allows the buckle 14 to move through the notch without restraint. In other words, the loop between straps 10 and 13 can be cinched up or loosened so as to make the opening 21 smaller or larger. And, when adjustments in the size of opening 21 are made, the buckle 14 on strap 13 is free to move through notch 17, and may end up below, within, or above the notch. Although the use of both spreaders, upper 6 and lower 7, provide for a maximum opening 21, either one of the spreaders may be used alone, providing a significant and useful degree of opening. The indentation 22 on the edge of the lower spreader 7 rests next to the grip of the pole 20 when the spreader is in place and provides a cradle for the grip.

The spreaders may be constructed of plastic, rubber, or metal with spring-like characteristics. They may be stamped from sheet material, or in the case of plastic may also be injection molded, thus making them very inexpensive to manufacture. The material must have slight flexibility so that the spreaders can conform to the shape of the hand as force is exerted on the straps in the performance of skiing. This is necessary so that the device will be comfortable and not interfere with the normal function of the ski straps. The material must also be resilient so that the parts will return to their former shape after the hand is released from the pole.

The slip-on upper spreader and the lower spreader have predetermined openings of size and shape to fit a wide range of straps produced by different manufacturers. The approximate dimensions of the overall device and the dimensions of the slots and notch that are described have been used successfully in prototypes, but are not the only ones that can be used. Other dimensions slightly larger or smaller could also be used. The slip-on upper spreader 6 shown in FIG. 1 and FIG. 2 can be constructed of either a flat piece or a curved piece. The flat-piece alternative is shown in FIG. 3. The curved piece alternative 23 is shown in FIG. 4. Either alternative will function satisfactorily. The curved piece can be attached with the concave side resting next to the pole grip, thus affording a more streamlined appearance.

I claim:

1. A spreader device for spreading the two straps of a ski pole or similar-type pole, making the sport of skiing and some other sports easier and more pleasurable, said spreader device comprising two parts, one designated as the upper spreader wherein said upper spreader attaches to the upper ends of said two straps near the top of the ski pole and the other part, designated as the lower spreader, attaches to the lower ends of said two straps where said two straps are fastened together by a buckle.

2. The spreader device of claim 1, comprising only one of said two parts, designated as the upper spreader, functions alone to spread said two straps.

3. The spreader device of claim 1, comprising only one of said two parts, designated as the lower spreader, functions alone to spread said two straps.

4. The spreader device of claim 1, wherein said upper and lower spreaders are made of plastic, rubber, or metal, which has resilient spring-like characteristics, whereby said spreaders can flex when the ski pole is grasped and return to their original shape when said pole is released.

5. The spreader device of claim 1, wherein said upper and lower spreaders may be stamped from sheet material, or, in the case of plastic, may be injection molded, whereby producing a useful product in large numbers that can be offered at a low price.

6. The spreader device of claim 1, wherein said upper spreader is comprised of two similar flat plates die-cut or molded in a V-shape or a U-shape and fastened together with snaps, or snaps and rivets, in predetermined locations such that said pair of straps of a ski pole are held between said flat plates of said upper spreader so as to form an open loop in said straps.

7. The spreader device of claim 1, wherein said upper spreader is a single flat plate of rectangular shape, said plate having two pairs of slots of predetermined shape and location, whereby one of said two straps is a strap without a buckle and this said strap without a buckle can be easily slipped through and securely held within one pair of said slots, and whereby the other one of said two straps is a strap with a buckle on its end and this said strap with a buckle can be easily slipped through and securely held within the other pair of said slots, whereby causing said two straps to be spread apart.

8. The spreader device of claim 7, wherein said pair of slots for holding said strap without a buckle is located at one end of said plate, oriented at an angle of about 45 degrees with the longitudinal axis of said plate, and the other pair of said slots for holding said strap with a buckle is located at the other end of said plate, oriented at an opposite angle of about 45 degree with the longitudinal axis.

9. The spreader device of claim 7, wherein said upper spreader may have the general shape of a curved plate in lieu of a flat plate, whereby having a more streamlined appearance.

10. The spreader device of claim 1, wherein said lower spreader has the general shape of a rectangular flat plate, said plate having two parallel slots of predetermined size and shape on one end whereby said strap without a buckle can be easily slipped through and securely held within said slots, and said plate also having an oversized notch of predetermined size and shape on the opposing end whereby the buckle on said strap with a buckle can pass through said oversized notch without restraint when the loop formed in said two straps is cinched up or loosened.

11. The spreader device of claim 10, wherein the pair of slots for holding said strap without a buckle is located on one end of said plate and oriented at an angle of about 90 degrees with the longitudinal axis of the said plate, and the notch for passing said buckle on said strap with a buckle is located on the opposite end of said plate and oriented an angle of about 90 degrees with the longitudinal axis of said plate.

12. The spreader device of claim 10, wherein said flat plate of the lower spreader has an indention in one of its edges that rests next to the grip of the ski pole, said indentation being concave in shape and of predetermined size and shape, whereby said grip will be cradled within said indentation providing a streamlined appearance.

13. A method of attaching a ski-pole-straps spreader device for spreading the two straps of a ski pole or similar type pole, said spreader device comprising two parts wherein one of said two parts, which is attached to said two straps near the top of said pole and designated as the upper spreader, is installed first, and the other one of said two parts, which is attached to the lower ends of said two straps where said two straps are buckled together and designated as the lower spreader, is installed next, whereby said upper and lower spreaders so installed cause said two straps to be spread apart.

14. The method of claim 13, wherein said upper spreader is comprised of two flat V-shaped plates with the corresponding legs of the “V” on both said plates fastened together with snaps or rivets, and is installed by unsnapping the snaps that hold said legs together, positioning the upper ends of said ski pole straps between said legs in predetermined locations that cause said straps to form an open loop, and refastening said snaps so as to hold said straps securely in place.

15. The method of claim 13, wherein said upper spreader is comprised of a rectangular flat plate with slots, and is installed in two steps: the first step consisting of passing said strap without a buckle down through an inside slot and up through an outside slot in one end of said slip-on spreader, then allowing said strap without a buckle to hang down vertically to be in position to be inserted in said lower spreader and subsequently be buckled to said strap with a buckle.

16. The method of claim 15, wherein said upper spreader is installed in the second step of aforementioned two steps by passing said strap with a buckle down through an inside slot and up through an outside slot in one end of said upper spreader then allowing said strap with a buckle to hang free to be inserted in said lower spreader and subsequently be buckled to the end of said strap without a buckle.

17. The method of claim 15, wherein after said upper spreader is in place near the top of said pole, said lower spreader is installed by passing said strap without a buckle down around an outside edge and threaded up through the outside slot and down through the inside slot of said lower spreader, then passing the other said strap with a buckle down through a notch in the opposite edge and buckling said two straps together.

18. The method of claim 13 wherein only the upper spreader is attached to said two straps near the top of said pole, whereby said upper spreader acts alone to spread said two straps.

19. The method of claim 13 wherein only the lower spreader is attached to said two straps at their lower ends where said two straps are buckled together, whereby said lower spreader acts alone to spread said two straps.
